(19) United States
(12) Patent Application Publication
(10) Pub. No.: US 2013/0141688 A1
(43) Pub. Date: Jun. 6, 2013

(54) LCD, LCD Substrate and LCD Manufacturing Method

(71) Applicant: Jun Wang, Shenzhen (CN)

(72) Inventor: Jun Wang, Shenzhen (CN)

(21) Appl. No.: 13/378,584

(22) PCT Filed: Dec. 7, 2011
(86) PCT No.: PCT/CN11/83646

§ 371 Date: Dec. 15, 2011

(30) Foreign Application Priority Data
Dec. 2, 2011 (CN) 2011103962917

(51) Int. Cl. G02F 1/1333; B05D 3/06; B05D 5/06

(52) U.S. Cl. 349/158; 427/162; 427/532

(57) ABSTRACT

The present invention discloses a Liquid Crystal Display (LCD), a LCD substrate and a LCD manufacturing method, wherein the substrate comprises a flat layer which is formed on the substrate; the boundary of the flat layer, to be coated with alignment liquid, is provided with a groove which is used to prevent the alignment liquid from diffusing; and the groove is formed on the surface of the flat layer. As the flat layer of the LCD substrate is provided with the groove for preventing the alignment liquid from diffusing, the uniform boundary of alignment layer is formed on the substrate, the range of the active area is expanded, and the frame width of the LCD panel is reduced. Under the action of blockage by the groove, the alignment liquid, when flowing to the setting area of sealant, cannot cause unreliable attachment of sealant, so that the groove can deflect to the sealant area, i.e. the boundary of alignment layer deflects to the sealant area, then the range of active area is further expanded, and the frame of the LCD panel is narrower.

### TECHNICAL FIELD

The present invention relates to the field of liquid crystal displays, in particular to a LCD substrate, a LCD and a LCD manufacturing method.

### BACKGROUND

The LCD panel is the main component of LCD, and includes an array substrate, a color film substrate and liquid crystals, wherein the liquid crystals are sealed between the array substrate and the color film substrate, and aligned by the alignment layer which is coated on the array substrate and color film substrate, so that the liquid crystals can be arranged in the specified direction to reach the display effect of the LCD panel.

FIG. 1 shows the alignment layer coating technology of the glass substrate of existing liquid crystal panels. As the alignment liquid (PI) would diffuse under the action of surface tension, and the surface of the edge of the glass substrate is not uniform or flat, the alignment liquid would be nonuniformly distributed on the edge of the substrate due to the influence by section difference between the circuits of array substrate and the section difference between the surfaces of Black Matrix (BM) of color film substrate, and even exceed the size of coating precision. As shown in FIG. 1, the alignment liquid should be uniformly diffused under ideal condition; however, under actual condition, the alignment liquid is nonuniformly diffused and would form a complex curve boundary.

FIG. 2 shows the cross section of the local edge of the existing LCD panel made by the coating technology in FIG. 1, and the LCD panel includes a color film substrate and an array substrate, wherein one side of the color film substrate has a top plate 10, and a flat layer 40 (OC) is arranged on the top plate 10; one side of the array substrate has a bottom plate 20, a flat layer 40 (OC) is arranged on the bottom plate 20, and an alignment layer 50 is coated on the flat layer 40 (OC). In FIG. 2, the line from A to A′ represents the active edge 101 of the active area; the line from B to B′ represents the alignment edge 51 of the alignment layer 50. Under the influence of the nonuniform diffusion of alignment layer through coating technology, the coating edge of the alignment layer 50 would generate the limitations of nonuniform diffusion, etc. (as shown in FIG. 1). Therefore, a space X must be kept between the active edge 101 and the alignment edge 51; or else, the edges in the active area are easy to form poor liquid crystal alignment or nonuniform display (mura) and the like.

In addition, as the alignment liquid forms the nonuniform diffusion on the coating boundary, the space X should be kept between the coating boundary and the edge of active area 101, and a gap should be remained between the coating boundary and the setting area of sealant 60, so as to avoid the phenomena that the alignment liquid diffuses to the setting area of sealant 60; the attachment of sealant 60 is poor; and the golden ball particles cannot transmit the signal of the array substrate to the color film substrate in a timely way. Due to these factors, the coating boundary of alignment liquid is severely affected, and the display range of LCD is further affected.

### SUMMARY

The present invention aims to provide a LCD, a LCD substrate and a LCD manufacturing method, wherein the LCD substrate has good alignment liquid coating effect and narrow frame.

The purpose of the present invention is achieved by the following technical schemes: a LCD substrate, wherein the substrate comprises a flat layer which is formed on the substrate; the boundary of the flat layer, to be coated with alignment liquid, is provided with a groove which is used to prevent the alignment liquid from diffusing; and the groove is formed on the surface of the flat layer.

Preferably, the width of the groove is 20-1,000 μm. According to the requirements of different LCD panels, the applicable width is selected to obtain a satisfactory boundary of alignment layer.

Preferably, the thickness of the flat layer is 2 μm, the depth of the groove is 2 μm, and the width of the groove is 100 μm. As the thickness of the alignment layer is only about 1,00 nm, preferably, the thickness of the flat layer is 2 μm, the depth of the groove is 2 μm, and the width of the groove is 100 μm. As a result, the groove can contain about 2,000 μm (the overflow amount when the groove is not used as the notch) of overflowed alignment liquid.

A LCD, comprising a substrate, wherein a flat layer is formed on the substrate; the boundary of the flat layer, to be coated with alignment liquid, is provided with a groove which is used to prevent the alignment liquid from diffusing; and the groove is formed on the surface of the flat layer.

Preferably, the width of the groove is 20-1,000 μm. According to the requirements of different LCD panels, the applicable width is selected to obtain a satisfactory boundary of alignment layer.

Preferably, the thickness of the flat layer is 2 μm, the depth of the groove is 2 μm, and the width of the groove is 100 μm. As the thickness of the alignment layer is only about 1.00 nm, preferably, the thickness of the flat layer is 2 μm, the depth of the groove is 2 μm, and the width of the groove is 100 μm. As a result, the groove can contain about 2,000 μm (the overflow amount when the groove is not used as the notch) of overflowed alignment liquid.

A LCD manufacturing method has the following steps: Step A: Form a groove on the boundary of the flat layer of substrate to be coated with the alignment liquid; Step B: Coat the alignment liquid.

Preferably, the groove is formed on the flat surface by the exposure machine through a photoetching method. The photoetching technology of the exposure machine has simple requirement and obvious effect.

Preferably, in step A, a bottom groove is formed on the film of the bottom of flat layer before coating, and then a groove is naturally formed on the flat layer. Before the flat layer is formed, a groove is formed on the bottom, and then a groove is formed on the applicable layer according to the technological requirements, so that the technological process is simple and the efficiency is improved.

As the flat layer of the LCD substrate is provided with the groove for preventing the alignment liquid from diffusing, the groove can absorb the diffused alignment liquid and further prevent the alignment liquid from diffusing. As a result, the alignment liquid is prevented from diffusing and forming nonuniform boundary on the array substrate and color film substrate with surface section difference, an uniform boundary is formed, and the alignment effect of the boundary of alignment liquid meet the requirement; furthermore, the boundary of the active area of the LCD can deflect to the boundary of the alignment layer, the range of the active area is expanded, and the frame width of the LCD panel is reduced. Under the action of blockage by the groove, the alignment liquid, when flowing to the setting area of sealant, cannot cause unreliable attachment of sealant, so that the groove can deflect to the sealant area, i.e. the boundary of alignment layer deflects to the sealant area, then the range of active area is further expanded, and the frame of the LCD panel is narrower.

### DESCRIPTION OF FIGURES

FIG. 1 is the practical and ideal conditions of the alignment layer coating technology of the existing LCD panels.

FIG. 2 is the diagram of existing LCD panels.

FIG. 3 is the section of LCD panel of the embodiment of the present invention.

FIG. 4 is the close-up view of the groove and flat layer of the embodiment of the present invention.

FIG. 5 is the schematic for illustrating the formation of alignment layer of the embodiment of the present invention.

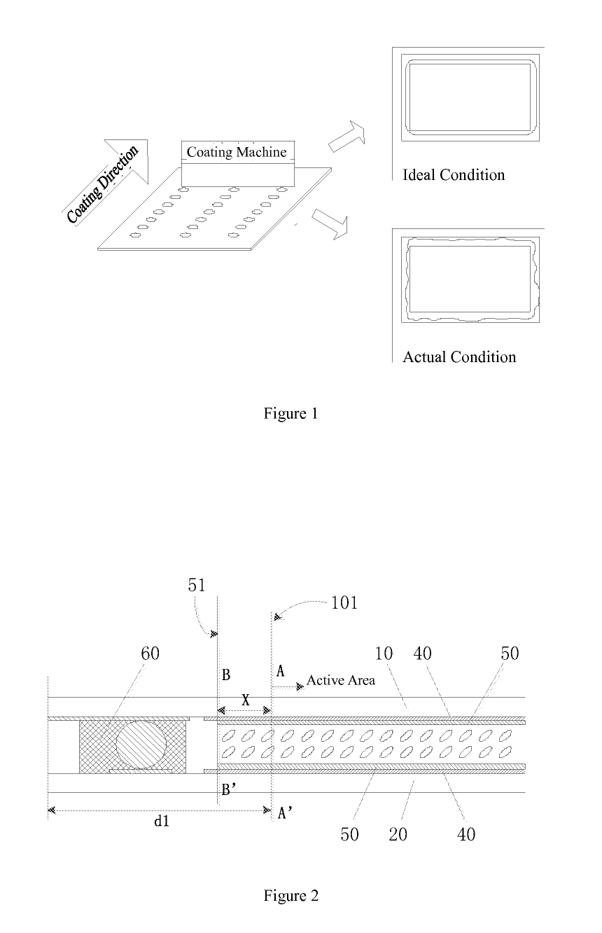

Wherein: 10. top plate, 20. bottom plate, 40. flat layer, 50. alignment layer, 51. boundary of alignment layer, 54. groove, 60. sealant, and 101. boundary of active area

### DETAILED DESCRIPTION

The present invention is further described by figures and the preferred embodiments as follows.

The present invention provides a LCD and a LCD manufacturing method. The LCD has a substrate, wherein a flat layer is formed on the substrate; an alignment layer is formed on the flat layer; and boundary of the upper surface of the flat layer (the surface formed by the alignment layer), to be coated with alignment liquid, is provided with a groove for preventing the alignment liquid from diffusing. The substrate includes an array substrate and a color film substrate.

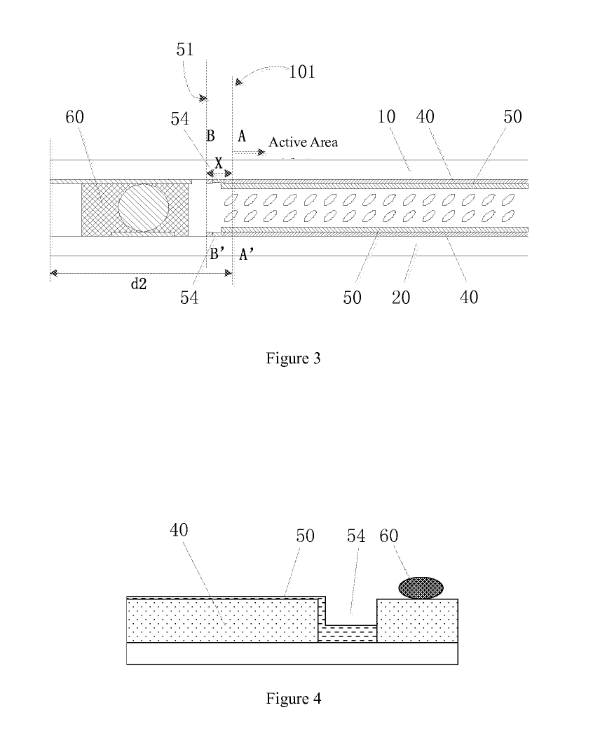

FIG. 3 shows the cross section of local edge of the LCD panel of the present invention, including a color film substrate and an array substrate. One side of the color film substrate has a top plate 10, and a flat layer 40 (OC) is arranged on the top plate 10; one side of the array substrate has a bottom plate 20, a flat layer 40 (OC) is arranged on the bottom plate 20, and an alignment layer 50 is coated on the flat layer 40 (OC); on the array substrate, as shown in FIG. 3, a groove 54 is arranged on the upper surface of the flat layer 40 at the alignment boundary 51 (refer to BB′) of the alignment layer 50, and is used to prevent the alignment liquid from diffusing out on the array substrate when the alignment liquid is coated on the array substrate, so that a good and uniform boundary of alignment layer is formed on the array substrate; also, a groove 54 is arranged on the upper surface of the flat layer 40 at the alignment boundary 51 of the alignment layer 50 of color film substrate, and is used to prevent the alignment liquid from diffusing out on the color film substrate when the alignment liquid is coated on the color film substrate.

As shown in FIG. 4, the groove 54 can absorb and contain the alignment liquid diffusing out, and then the alignment fluid is prevented from further diffusing into the sealant 60 outside the groove 54, so as to avoid influence of diffused liquid on the attachment of sealant, and further protect the attachment tightness of the sealant 60. The width of the groove 54 is 20-1,000 μm. For example, when the width of the groove is 100 μm in this embodiment, the thickness of the alignment liquid is only 100 nm, but the thickness of the flat layer is 2 μm; the groove is formed through the photoetching method, and the depth is the same with the thickness of the flat layer, and is 20 times as thick as the thickness of the alignment liquid. Therefore, the groove can contain about 2,000 μm (the overflow amount when the groove is not used as the notch) of alignment liquid.

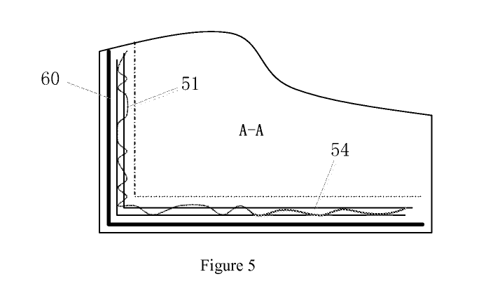

As shown in FIG. 5, the diffusion of alignment liquid is limited by the groove 54. After the alignment liquid is diffused to the groove 54, the alignment liquid is absorbed and contained by the groove 54, and then cannot continue to diffuse towards the sealant 60, so that the formed diffusion area of the alignment layer is reduced, i.e. the diffusion width is reduced, and the good and uniform boundary 52 of alignment layer can be formed on the color film substrate and array substrate. As the uniformity of the boundary 51 of alignment layer is improved, the alignment effect is satisfactory at the boundary, and the boundary of active area deflects to the boundary 51 of alignment layer so as to expand the range of active area and reduce the frame width of the LCD panel. Under the action of absorption and blockage by the groove 54, the alignment liquid, when flowing to the setting area of sealant, cannot cause unreliable attachment of sealant 60, so that the groove can deflect to the sealant area, i.e. the boundary of alignment layer deflects to the sealant area, then the range of active area is further expanded, and the frame of the LCD panel is narrower.

FIG. 3 shows the LCD panel of the embodiment of the present invention, and the width d2 of the frame is as shown in the figure. FIG. 2 shows the structure of an existing LCD panel, and the width d1 of the frame is as shown in the figure. When the structures of the LCD panels with same size are compared, d2 is less than d1, i.e. the frame of the LCD panel in this embodiment is narrower than the frame of the existing LCD panel.

In the present invention, A LCD manufacturing method has the following steps:

Step A: Form a groove on the boundary of the flat layer of substrate to be coated with the alignment liquid.

Step B: Coat the alignment liquid.

The groove is formed on the flat surface by the exposure machine through a photoetching method, or a bottom groove is formed on the film of the bottom of flat layer before coating, and then a groove is naturally formed on the flat layer.

The above content is detailed description of the present invention by using specific preferred embodiments. However, this present invention is not limited to these specific embodiments. For the ordinary technical personnel in the technical field of the present invention, on the premise of keeping the conception of the present invention, the technical personnel can also make simple deductions or replacements, and all of which should be considered to belong to the protection scope of the present invention.

1. A LCD substrate, comprising: a flat layer which is formed on the substrate; the boundary of the flat layer, to be coated with alignment liquid, is provided with a groove which is used to prevent the alignment liquid from diffusing; and the groove is formed on the surface of the flat layer.

2. A LCD substrate of claim 1, wherein the width of the groove is 20-1,000 μm.

3. A LCD substrate of claim 2, wherein the thickness of the flat layer is 2 μm, the depth of the groove is 2 μm, and the width of the groove is 1,00 μm.

4. A LCD, comprising a substrate; a flat layer is formed on the substrate; the boundary of the flat layer, to be coated with alignment liquid, is provided with a groove which is used to prevent the alignment liquid from diffusing; and the groove is formed on the surface of the flat layer.

5. A LCD of claim 1, wherein the width of the groove is 20-1,000 μm.

6. A LCD of claim 1, wherein the thickness of the flat layer is 2 μm, the depth of the groove is 2 μm, and the width of the groove is 1,00 μm.

7. A LCD manufacturing method, comprising the following steps:
Step A: form a groove on the boundary of the flat layer of substrate to be coated with the alignment liquid.
Step B: coat the alignment liquid.

8. A LCD manufacturing method of claim 7, wherein the groove is formed on the surface of the flat layer by the exposure machine through a photoetching method.

9. A LCD manufacturing method of claim 7, wherein in the step A, a bottom groove is formed on the film of the bottom of flat layer before coating, and then a groove is naturally formed on the flat layer.
